(19) United States
(12) Patent Application Publication
(10) Pub. No.: US 2015/0055348 A1
(43) Pub. Date: Feb. 26, 2015

(54) LIGHT EMITTING MODULE

(71) Applicant: SAMSUNG ELECTRONICS CO., LTD., Suwon-si (KR)

(72) Inventors: Sang Woo HA, Seongnam-si (KR); Jin Ha Kim, Yongin-si (KR); Chin Woo Kim, Hwaseong-si (KR)

(73) Assignee: SAMSUNG ELECTRONICS CO., LTD.

(21) Appl. No.: 14/297,400

(22) Filed: Jun. 5, 2014

(30) Foreign Application Priority Data
Aug. 23, 2013 (KR) 10-2013-0100418

(51) Int. Cl. F21V 7/00

(52) U.S. Cl. CPC F21V 7/00
USPC 362/296.01

(57) ABSTRACT

A light emitting module is provided including a light emitting device and a reflective member disposed on the light emitting device. The reflective member includes a hole with an inner wall thereof provided as a reflective surface, having a lower aperture having a quadrangular shape and an upper aperture having a shape geometrically different from that of the lower aperture. The inner wall includes first to fourth inclined surfaces extending from respective sides of the lower aperture to the upper aperture, and first to fourth connection surfaces extending from a respective vertex of the lower aperture to the upper aperture to connect the inclined surfaces to each other. The illuminance distribution of emitted light has a quadrangular shape. Accordingly, a relatively high degree of design freedom may be secured for a reflective member while maintaining required illuminance distribution characteristics.

### CROSS-REFERENCE TO RELATED APPLICATION

This application claims the benefit of Korean Patent Application No. 10-2013-0100418 filed on Aug. 23, 2013, with the Korean Intellectual Property Office, the disclosure of which is incorporated herein by reference.

### BACKGROUND

Semiconductor light emitting devices emit light using a principle in which electrons and holes are recombined when a current is applied thereto, and have been widely used due to advantages such as relatively low power consumption and high brightness, miniaturizability, and the like. In particular, after the development of nitride light emitting devices, the practical range thereof has been further extended such that the nitride light emitting devices have been employed in camera flashes, general illumination devices, light sources for headlight, and the like. Light emitting modules using such semiconductor light devices commonly include reflective members so as to be able to implement required illuminance distribution characteristics, based on causes that semiconductor light emitting devices have directivity of light or the like. Research into light emitting modules for implementing required illuminative distribution using reflective members has been undertaken.

### SUMMARY

An embodiment of the disclosure may provide a light emitting module for securing a relatively high degree of design freedom of a reflective member.

According to an aspect of the disclosure, a light emitting module includes a light emitting device, and a reflective member disposed on the light emitting device. The reflective member includes a hole with an inner wall thereof provided as a reflective surface. The hole has a lower aperture having a quadrangular shape and an upper aperture having a shape geometrically different from that of the lower aperture. The inner wall includes first to fourth inclined surfaces extending from respective sides of the lower aperture to the upper aperture, and first to fourth connection surfaces extending from a respective vertex of the lower aperture to the upper aperture respectively disposed between the inclined surfaces so as to connect the inclined surfaces to each other. The illuminance distribution of light emitted through the upper aperture on a light emission surface has a substantially quadrangular shape.

The first to fourth connection surfaces may have a width gradually increasing toward the upper aperture.

The first inclined surface and the second inclined surface, as well as the third inclined surface and the fourth inclined surface, may face each other, and the first and second inclined surfaces may be disposed such that a length of a side thereof adjacent the upper aperture is shorter than that of a side adjacent the lower aperture.

The first inclined surface and the second inclined surface may have widths that gradually reduce from respective sides of the lower aperture toward the upper aperture.

The third and fourth inclined surfaces may be disposed such that a length of a side thereof adjacent the upper aperture is the substantially same as that of a side adjacent the lower aperture.

The first inclined surface and the second inclined surface, and the third inclined surface and the fourth inclined surface, may have substantially the same shape as each other, respectively, and the first inclined surface and the third inclined surface may have different shapes.

The first to fourth inclined surfaces may have substantially the same shape. In this case, the first to fourth inclined surfaces may have remaining sides having a parabola shape, except for sides adjacent the lower aperture.

At least one of the first to fourth inclined surfaces may include a curved portion.

The upper aperture may have a substantially octagonal shape.

The upper aperture may have a substantially circular shape.

The light emitting module may further include a package body receiving the light emitting device therein, and the reflective member may be disposed on the package body.

The light emitting module may further include a package body having a cavity receiving the light emitting device therein, and the reflective member may be provided as a reflective material layer formed on an inner wall of the cavity.

According to another aspect of the disclosure, a light emitting module includes a light emitting device, and a reflective member disposed on the light emitting device. The reflective member includes a hole with an inner wall thereof provided as a reflective surface. The hole has a lower aperture having a quadrangular shape and an upper aperture having a shape geometrically different from that of the lower aperture. The inner wall includes an inclined surface extending from a respective side of the lower aperture to the upper aperture, the inclined surface having a curvature gradually increasing from the lower aperture toward the upper aperture. Illuminance distribution of light emitted through the upper aperture on a light emission surface has a quadrangular shape.

The inclined surface may have a curvature gradually increasing from 0 in a region adjacent the upper aperture.

According to another aspect of the disclosure, a light emitting module comprises a package body having a pair of lead frames and a light emitting device disposed on of the pair of lead frames. A reflective member including a hole and a reflective inner wall surface is disposed on the package body, so that the light emitting device is located inside the hole and the light emitting device is surrounded by the reflective inner wall surface. The hole has a lower aperture adjacent the package body having a quadrangular shape and an upper aperture having a rounded shape. An area of the upper aperture is greater than an area of the lower aperture.

In certain embodiments of the light emitting module, the inner wall surface includes a first pair of inclined opposing sides extending from the lower aperture to the upper aperture and first widths of the first pair of inclined sides extending along the lower aperture are greater than corresponding second widths of the first pair of inclined sides extending along the upper aperture. The inner wall surface includes a second pair of inclined surfaces extending from the lower aperture to the upper aperture and first widths of the second pair of inclined sides extending along the lower aperture are less than corresponding second widths of the second pair of inclined sides extending along the upper aperture.

In certain embodiments of the light emitting module, the upper aperture may be substantially circular-shaped.

In certain embodiments of the light emitting module, the upper aperture is n-sided polygon shaped, wherein n is 5 or more. In certain embodiments, the upper aperture may be substantially octagonal-shaped.

### BRIEF DESCRIPTION OF THE DRAWINGS

The above and other aspects, features and other advantages will be more clearly understood from the following detailed description taken in conjunction with the accompanying drawings.

FIG. 1 is an exploded perspective view of a light emitting module according to an embodiment of the disclosure.

FIG. 2 is a cross-sectional view of the light emitting module taken along line A-A′ of FIG. 1 according to the embodiment.

FIG. 3A illustrates an upper surface of a reflective member according to the embodiment with reference to FIG. 1, and FIGS. 3B and 3C are cross-sectional views of the upper surface taken along line B-B′ and line C-C′ of FIG. 3A.

FIG. 4 is a perspective view of the reflective member taken along line D-D′ of FIG. 3A.

FIG. 5 is a drawing illustrating an illuminance distribution simulation result of the light emitting module according to the embodiment.

FIGS. 6 and 7 are perspective views of a reflective member applied to a light emitting module according to another embodiment of the disclosure.

FIG. 8 is a cross-sectional view of a light emitting module according to another embodiment.

FIG. 9 is a perspective view illustrating a camera to which a light emitting module is applied according to an embodiment.

FIG. 10 is an exploded perspective view illustrating an illumination device to which a light emitting module is applied according to an embodiment.

### DETAILED DESCRIPTION

Embodiments of the disclosure will now be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

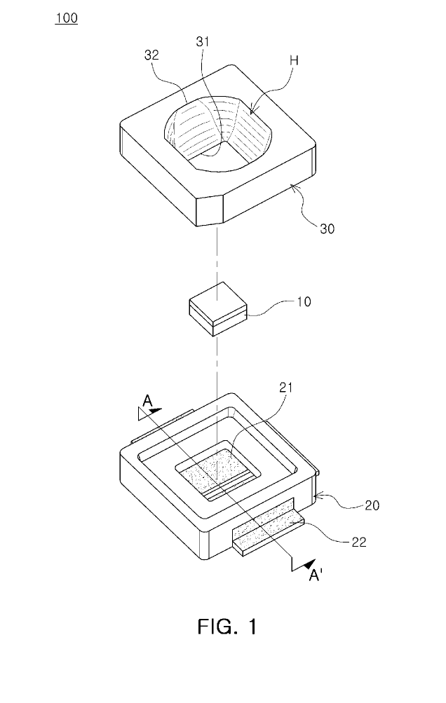

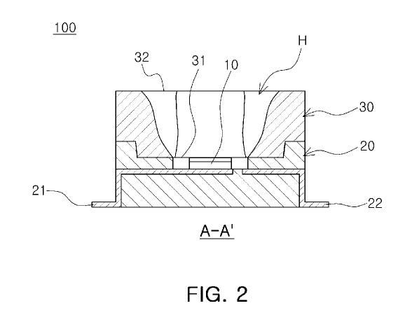

FIG. 1 is an exploded perspective view of a light emitting module 100 according to an embodiment of the disclosure, and FIG. 2 is a cross-sectional view of the light emitting module taken along line A-A′ of FIG. 1 according to the embodiment.

With reference to FIGS. 1 and 2, the light emitting module 100 according to the embodiment includes a light emitting device 10 and a reflective member 30 disposed on the light emitting device 10.

The light emitting device 10 may be any light emitting device as long as it can emit light when an electrical signal is applied thereto. For example, a semiconductor light emitting device formed by epitaxially growing a semiconductor layer on a growth substrate may be used. The light emitting device 10 may include an n-type semiconductor layer, a p-type semiconductor layer and an active layer formed between the n-type semiconductor layer and the p-type semiconductor layer, but should not be considered as being limited thereto. Here, the active layer may be configured of a nitride semiconductor including InₓAl_{y}Ga_{1-x-y}N (0≦x≦1, 0≦y≦1, and x+y≦1) formed to have a single or multiple quantum well (MQW) structure. The light emitting device 10 may emit blue light, but should not be considered as being limited thereto.

According to the present embodiment, the light emitting module 100 may include a package body 20 receiving the light emitting device 10. The package body 20 may be formed using an opaque resin or a resin having a relatively high degree of reflectivity, and in addition, a polymer resin facilitating an injection process may be used therefor, but the disclosure should not be considered as being limited thereto. For example, various nonconductive materials may be used.

The package body 20 may include a pair of lead frames 21 and 22. The pair of lead frames 21 and 22 may be electrically connected to the light emitting device 10 through a conductive wire or through contact therebetween, and may be used as terminals through which an external electrical signal is applied. To this end, the lead frames 21 and 22 may be formed of a metal having relatively excellent electrical conductivity.

The reflective member 30 may be disposed on the light emitting device 10 and the present embodiment illustrates a form in which the reflective member 30 is disposed on the package body 20 having the light emitting device 10 received therein. The reflective member 30 may include a hole H with an inner wall thereof provided as a reflective surface, and the hole H may have a lower aperture 31 adjacent the light emitting device 10 and an upper aperture 32 formed in a position opposed thereto.

Illuminance distribution of the light emitting module 100 may be controlled by the reflective member 30 having the hole H with the inner wall thereof used as a reflective surface. The illuminance distribution may generally be controlled to be formed to have a shape corresponding to the shapes of the lower aperture 31 and the upper aperture 32 of the hole H. In detail, in order to implement quadrangular illuminance distribution, a method of employing the lower aperture 31 and the upper aperture 32 having a quadrangular shape may be considered. However, in this case, since a shape of the upper aperture 32 should be designed according to required illuminance distribution, a problem in which a relatively high degree of design freedom is not secured may occur.

Thus, in the case of the light emitting module according to the present embodiment, the lower aperture 31 may have a quadrangular shape so as to correspond to a required illuminance distribution shape, for example, a quadrangular shape, while the upper aperture 32 may have a shape geometrically different from that of the lower aperture 31. Here, the geometrically different shape may be considered to be applied in a case other than a case in which only sizes are different from each other while having the same shape. For example, the geometrically different shape may be in a relationship between a quadrangular shape and an n-polygon shape, where n is a natural number of 5 or more, a relationship between a quadrangular shape and a circular shape, or the like. For example, in the case of the light emitting module 100 according to the present embodiment, it may also be considered that the upper aperture 32 of the hole H in the reflective member 30 has a shape different from a required illuminance distribution shape.

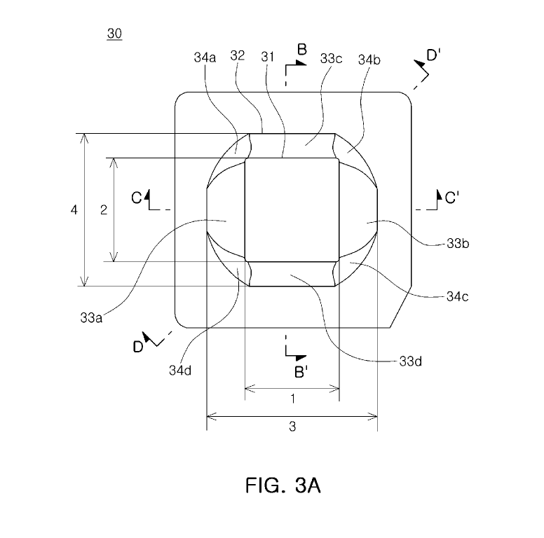

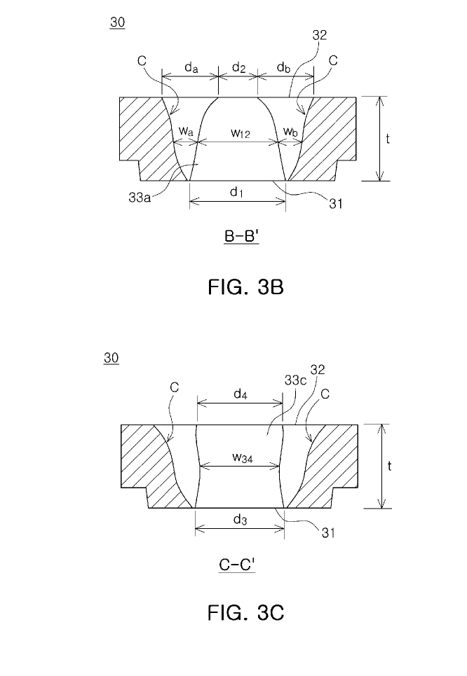

As such, although the upper aperture 32 may have a shape geometrically different from a required illuminance distribution shape, for example, a quadrangular shape, the light emitting module 100 may have a quadrangular illuminance distribution of light emitted through the upper aperture 32 on a light emission surface. This result may be obtained by controlling an inner wall of the hole H provided as a reflective surface to be divided into a plurality of surfaces and will be described with reference to FIGS. 3A to 3C and FIG. 4.

FIG. 3A illustrates an upper surface of the reflective member 30 according to the embodiment, and FIGS. 3B and 3C are cross-sectional views of the upper surface taken along line B-B′ and line C-C′ of FIG. 3A. FIG. 4 is a perspective view of the reflective member 30 taken along line D-D′ of FIG. 3A.

With reference to FIGS. 3A to 3C and FIG. 4, the inner wall of the hole H provided in the reflective member 30 according to the present embodiment may include first to fourth inclined surfaces 33a to 33d extending from respective sides of the lower aperture 31 to the upper aperture 32, and first to fourth connection surfaces 34a to 34d extending from a respective vertex of the lower aperture 31 to the upper aperture 32 to be respectively formed between the inclined surfaces 33a to 33d so as to connect the inclined surfaces to each other.

The first inclined surface 33a may be formed to face the second inclined surface 33b and the third inclined surface 33c may face the fourth inclined surface 33d. The first connection surface 34a may be formed between the first and third inclined surfaces 33a and 33c to connect the first inclined surface 33a to the third inclined surface 33c. The second connection surface 34b may be formed between the second and third inclined surfaces 33b and 33c to connect the second inclined surface 33b to the third inclined surface 33c. The third and fourth connection surfaces 34c and 34d may be respectively formed between the second and fourth inclined surfaces 33b and 33d and between the first and fourth inclined surfaces 33a and 33d to connect therebetween.

With reference to FIG. 3B, in the case of the first and second inclined surfaces 33a and 33b, a length of a side d₂ adjacent to the upper aperture 32 may be shorter than that of a side d₁ adjacent to the lower aperture 31. For example, the first and second inclined surfaces 33a and 33b may have a width W₁₂ gradually reducing from one side of the lower aperture 31 toward the upper aperture 32.

Therefore, the first to fourth connection surfaces 34a to 34d may have a width W, or W_{b} gradually increasing toward the upper aperture 32, and as a length of a side dₐ or d_{b} adjacent to the upper aperture 32 provided by the first to fourth connection surfaces 34a to 34d is increased, the upper aperture 32 may be provided to have an octagonal shape.

Here, the octagonal shape is not limited to a geometrically perfect octagonal shape, and may also be defined as including a form in which among four pairs of sides facing each other, two pairs of sides in which the first to fourth connection surfaces 34a to 34d contacting the upper aperture 32 are rounded, as in the case of a shape of the upper aperture 32 shown in FIG. 3A.

In addition, in the case of the third and fourth inclined surfaces 33c and 33d with reference to FIG. 3C, a length of a side d₄ adjacent the upper aperture 32 may be substantially the same as that of a side d₃ adjacent the lower aperture 31. In this case, unlike the first and second inclined surfaces 33a and 33b of which the widths W₁₂ gradually reduce from a respective side of the lower aperture 31 toward the upper aperture 32, since the third and fourth inclined surfaces 33c and 33d having a substantially uniform width W₃₄ are applied thereto. Illuminance distribution characteristics may be exhibited in a rectangular shape of which a length of one side is relatively longer, but the disclosure should not be considered as being limited thereto.

According to the present embodiment, at least one of the first to fourth inclined surfaces 33a to 33d may include a curved portion C. In detail, with reference to FIGS. 3B and 3C, the first to fourth inclined surfaces 33a to 33d may respectively be provided as surfaces including a predetermined curved portion C. As such, the curved portion C formed in the inclined surfaces may allow for interference due to light changed when light emitted from the light emitting device 10 is reflected by the first to fourth inclined surfaces 33a to 33d, and a degree of curvature of the curved portion may be set to be suitable for required illuminance distribution characteristics.

Inclined surfaces facing each other among the first to fourth inclined surfaces 33a to 33d may have the same shape as each other. In detail, the first inclined surface 33a and the second inclined surface 33b, and the third inclined surface 33c and the fourth inclined surface 33d may have the same shape. In this case, illuminance distribution of the light emitting module 100 may be effectively provided to have both bilateral and vertical symmetry.

On the other hand, inclined surfaces not facing each other, among the first to fourth inclined surfaces 33a to 33d, may have different shapes. For example, the first and third inclined surfaces 33a and 33c may have different shapes, but are not limited thereto. Thus, the first to fourth inclined surfaces 33a to 33d may have the same shape.

A depth of the hole H formed in the reflective member 30, a distance t between the lower aperture 31 and the upper aperture 32, may be selected to be within a range suitable therefor depending on the size of the lower aperture 31 and the upper aperture 32. In detail, as the depth of the hole H is increased, illuminance distribution implemented by the light emitting module 100 may be significantly affected by a shape of the upper aperture 32. In this case, required illuminance distribution characteristics, for example, a quadrangular shape, may not be obtained. Therefore, the depth of the hole H may be selected to be within a range suitable therefor depending on the size of the lower aperture 31 and the upper aperture 32. For example, according to an embodiment, in the case of the hole H including the lower aperture 31 of which a length of a side 1 and a length of a side 2 are 1.39 mm and 1.51 mm, respectively, and the upper aperture 32 of which a length of line 3 and a length of line 4, virtual lines of which, when interposed on the octagonal shape, intersect in a position corresponding to a center thereof, so as to be centered thereon, are 2.52 mm and 2.27 mm, respectively. A distance t between the lower aperture 31 and the upper aperture 32 may be set to 1.22 mm. Here, tolerance thereof may respectively be 0.03 mm.

However, since the values described above are provided by way of example so as to allow for a clear understanding of the disclosure, the disclosure should not be considered as being limited thereto.

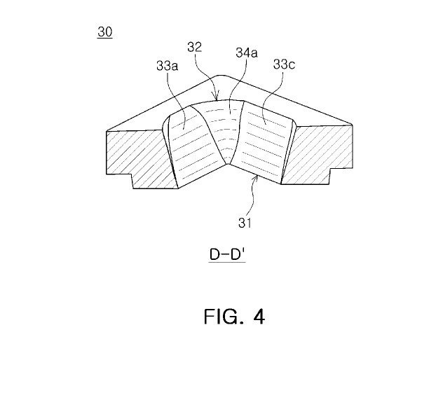

FIG. 5 is a drawing illustrating an illuminance distribution simulation result of the light emitting module 100 according to the embodiment. In this embodiment, lengths of sides 1 and 2 of the lower aperture 31, lengths of lines 3 and 4 of the upper aperture 32 as described above, and a distance t between the lower aperture 31 and the upper aperture 32 are set as described above.

With reference to FIG. 5, it can be appreciated that the light emitting module according to the present embodiment may be implemented such that although the upper aperture 32 of the hole H formed in the reflective member 30 has a shape geometrically different from a quadrangular shape, illuminance distribution having a quadrangular shape may be implemented. Here, the quadrangular illuminance distribution described above may be defined as including a quadrangular shape having a portion in which a vertex region thereof is rounded, rather than being limited to a perfectly quadrangular shape having four vertices.

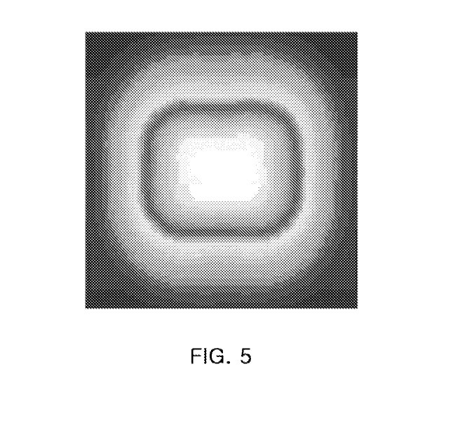

FIG. 6 is a perspective view of a reflective member 40 applied to a light emitting module according to another embodiment of the disclosure. With reference to FIG. 6, the reflective member 30 according to the present embodiment may include a hole H with an inner wall thereof provided as a reflective surface, and the hole H may have a lower aperture 41 adjacent to a light emitting device and an upper aperture 42 formed in a position opposed thereto. The lower aperture 41 may have a quadrangular shape, while the upper aperture 42 may have a shape geometrically different from that of the lower aperture 41.

The inner wall of the hole H may include first to fourth inclined surfaces 43a to 43d extending from respective sides of the lower aperture 41 to the upper aperture 42, and first to fourth connection surfaces 44a to 44d extending from a respective vertex of the lower aperture 41 to the upper aperture 42, respectively formed between the inclined surfaces 43a to 43d so as to connect the inclined surfaces 43a to 43d to each other.

According to the present embodiment, the first to fourth inclined surfaces 43a to 43d may have the same shape. The first to fourth inclined surfaces 43a to 43d may have a width W₅ gradually reducing from one side of the lower aperture 41 toward the upper aperture 42. In the case of the present embodiment, the first to fourth inclined surfaces 43a to 43d may have remaining sides having a parabola shape, except for sides adjacent to the lower aperture 41. The parabola shape of the sides as above may have a form in which an inflection point thereof contacts one side of the upper aperture 42.

Therefore, although the upper aperture 42 may have a substantially circular shape, the inner wall of the hole H formed in the reflective member 40 may include the first to fourth inclined surfaces 43a to 43d and the first to fourth connection surfaces 44a to 44d, such that the light emitting module may implement quadrangular illuminance distribution.

FIG. 7 is a perspective view of a reflective member 50 applied to a light emitting module according to another embodiment of the disclosure.

With reference to FIG. 7, the reflective member 50 according to the present embodiment may include a hole H with an inner wall thereof provided as a reflective surface, and the hole H may have a lower aperture 51 adjacent to a light emitting device and an upper aperture 52 formed in a position opposed thereto. In the present embodiment, the lower aperture 51 may have a quadrangular shape, while the upper aperture 52 may have a shape geometrically different from that of the lower aperture 51.

According to the present embodiment, the inner wall of the hole H may include an inclined surface 53 extending from a respective side of the lower aperture 51 to the upper aperture 52, and the inclined surface 53 may have a curvature increased from the lower aperture 51 toward the upper aperture 52. For example, the inclined surface 53 may have a curvature in a region r1 adjacent to the lower aperture 51, greater than that in a region R2 in a region adjacent to the upper aperture 52.

In detail, in the region adjacent to the lower aperture 51, the curvature is 0, and the curvature may gradually increase from 0 in the region thereof adjacent the upper aperture 52. Here, the curvature may be defined as setting the center of curvature in an optional space surrounded by the inner wall of the hole H.

In the light emitting module according to the present embodiment, the lower aperture 51 of the hole H may have a quadrangular shape by adjusting the curvature of the inclined surface 53, while the upper aperture 52 may have a circular shape and illuminance distribution of light emitted through the upper aperture 52 on a light emission surface may have a quadrangular shape.

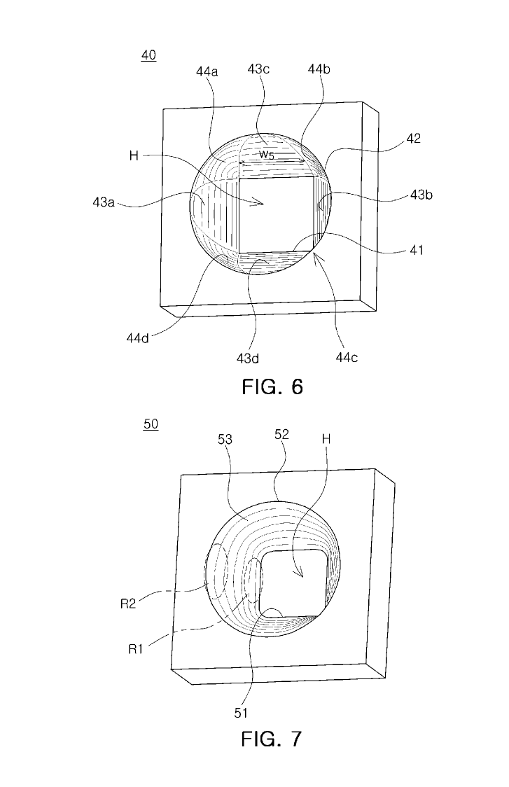

FIG. 8 is a cross-sectional view of a light emitting module 200 according to another embodiment.

With reference to FIG. 8, the light emitting module 200 according to the present embodiment may include a package body 120 having a cavity g receiving a light emitting device 110 therein. The light emitting device 110 is disposed on the package body 120. The package body 120 may include a pair of lead frame 121 and 122 terminals applying an electrical signal to the light emitting device 110.

The package body 120 may be formed using an opaque resin or a resin having a relatively high degree of reflectivity. A polymer resin facilitating an injection process may be used therefor, but the disclosure should not be considered as being limited thereto. For example, various nonconductive materials may also be used.

In the present embodiment, the cavity g of the package body 120 may be formed in an upper part of the light emitting device 110, so as to be provided in a hole having a lower aperture 131 adjacent to the light emitting device 110 and an upper aperture 132 formed in a position opposed thereto. Here, the lower aperture 131 may have a quadrangular shape, and the upper aperture 132 may have a shape geometrically different from that of the lower aperture 131.

According to the present embodiment, a reflective material layer 130 may be formed on an inner wall of the cavity g. For example, in the present embodiment, the reflective member described in the foregoing embodiment is provided by the reflective material layer 130 formed on the inner wall of the cavity g.

In this case, the inner wall of the cavity g on which the reflective material layer 130 is formed may include first to fourth inclined surfaces extending from a respective side of the lower aperture 131 to the upper aperture 132, and first to fourth connection surfaces extending from a respective vertex of the lower aperture 131 to the upper aperture 132 to be respectively formed between the inclined surfaces so as to connect the inclined surfaces to each other.

In addition, the inner wall of the cavity g on which the reflective material layer 130 is formed may include an inclined surface extending from a respective side of the lower aperture 131 to the upper aperture 132, and the inclined surface may have a curvature increasing from the lower aperture 131 toward the upper aperture 132.

Accordingly, as described in the foregoing embodiments, the light emitting module 200 according to the present embodiment may secure a relatively high degree of design freedom of the upper aperture 132 while implementing a required shape of illuminance distribution, for example, a quadrangular shape.

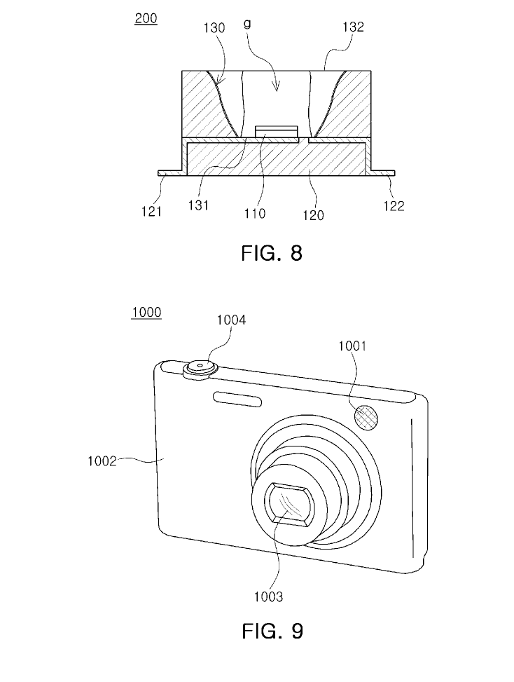

FIG. 9 is a perspective view illustrating a camera 1000 comprising a light emitting module according to an embodiment of the disclosure. The camera 1000 according to the present embodiment may include a digital single lens reflex (DSLR), hybrid digital cameras, camcorders, and the like.

With reference to FIG. 9, the camera 1000 may include a camera body 1002, an image capturing part 1003 provided to acquire an image to be photographed, a manipulation part 1004 applying turn-on/off power to the camera 1000 or receiving an operation command, such as an image capturing command or the like through a user input, and a flash part 1001.

The flash part 1001 may irradiate light on a subject in order to obtain an illuminating effect and may include a light emitting module as alight source. As the light emitting module, the light emitting module described in the foregoing embodiment may be used. In this case, the light emitting module may include a reflective member having a hole including an upper aperture and a lower aperture. Illuminance distribution of light emitted through the upper aperture on a light emission surface may have a quadrangular shape. Thus, light may be evenly irradiated on an area corresponding to an entire image shape, for example, a quadrangular shape, with respect to an image captured by the camera 1000. At this time, the flash part 1001 may have a shape similar to that of the upper aperture of the light emitting module, for example, a shape similar to an octagonal shape or a circular shape.

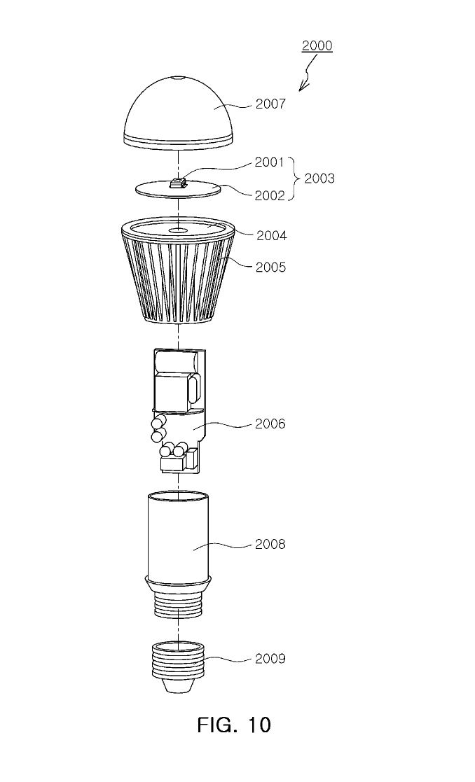

FIG. 10 is an exploded perspective view illustrating an illumination device 2000 to which a light emitting module according to an embodiment is applied.

With reference to the exploded perspective view of FIG. 10, an illumination device 2000 may include a light emitting unit 2003, a driving unit 2006, and an external connection unit 2009. In addition, the illumination device 2000 may further include an outer structure such as external and internal housings 2005 and 2008, and a cover unit 2007. The light emitting unit 2003 may include, for example, the light emitting module described in the foregoing embodiment and a circuit board 2002 having the light emitting module mounted thereon. Although the present embodiment illustrates a form in which a single light emitting module 2001 is mounted on a circuit board 2002, a plurality of light emitting modules may be mounted thereon as needed.

In addition, the light emitting unit 2003 may include an external housing 2005 operating as a heat emission part, and the external housing 2005 may include a heat emission plate 2004 directly contacting the light emitting unit 2003 to improve a heat emission effect.

The illumination device 2000 may include the cover unit 2007 mounted on the light emitting module 2003 and having a convex lens shape. The driving unit 2006 may be mounted in the internal housing 2008 to receive power supply from the external connection unit 2009 having, for example, a socket structure. In addition, the driving unit 2006 may serve to convert the received power into a current source appropriate for driving the light emitting module 2001 of the light emitting unit 2003 to then provide the converted current. The driving unit described above may include a rectifying unit and a direct current DC-DC converter.

As set forth above, in a light emitting module according to an embodiment, illuminance distribution may not be limited to an aperture shape of a reflective member, and a relatively high degree of design freedom may be secured.

While the disclosure has been shown and described in connection with embodiments, it will be apparent to those skilled in the art that modifications and variations could be made without departing from the spirit and scope of the present disclosure as defined by the appended claims.

What is claimed is:

1. A light emitting module comprising:
a light emitting device; and
a reflective member disposed on the light emitting device and including a hole with an inner wall thereof provided as a reflective surface,
wherein the hole has a lower aperture having a quadrangular shape and an upper aperture having a shape geometrically different from that of the lower aperture,
wherein the inner wall includes first to fourth inclined surfaces extending from respective sides of the lower aperture to the upper aperture, and first to fourth connection surfaces extending from a respective vertex of the lower aperture to the upper aperture respectively disposed between the inclined surfaces so as to connect the inclined surfaces to each other, and
wherein illuminance distribution of light emitted through the upper aperture on a light emission surface has a substantially quadrangular shape.

2. The light emitting module of claim 1, wherein the first to fourth connection surfaces have a width gradually increasing toward the upper aperture.

3. The light emitting module of claim 1, wherein the first inclined surface and the second inclined surface, and the third inclined surface and the fourth inclined surface face each other, and
the first and second inclined surfaces are disposed such that a length of a side thereof adjacent the upper aperture is shorter than that of a side adjacent the lower aperture.

4. The light emitting module of claim 3, wherein the first inclined surface and the second inclined surface have widths that gradually reduce from respective sides of the lower aperture toward the upper aperture.

5. The light emitting module of claim 3, wherein the third and fourth inclined surfaces are disposed such that a length of a side thereof adjacent the upper aperture is substantially same as that of a side adjacent the lower aperture.

6. The light emitting module of claim 3, wherein the first inclined surface and the second inclined surface, and the third inclined surface and the fourth inclined surface, have substantially a same shape as each other, respectively, and
the first inclined surface and the third inclined surface have different shapes.

7. The light emitting module of claim 3, wherein the first to fourth inclined surfaces have substantially a same shape.

8. The light emitting module of claim 7, wherein the first to fourth inclined surfaces have remaining sides having a parabola shape, except for sides adjacent the lower aperture.

9. The light emitting module of claim 1, wherein at least one of the first to fourth inclined surfaces includes a curved portion.

10. The light emitting module of claim 1, wherein the upper aperture has a substantially octagonal shape.

11. The light emitting module of claim 1, wherein the upper aperture has a substantially circular shape.

12. The light emitting module of claim 1, further comprising a package body receiving the light emitting device therein,
wherein the reflective member is disposed on the package body.

13. The light emitting module of claim 1, further comprising a package body having a cavity receiving the light emitting device therein,
wherein the reflective member is provided as a reflective material layer formed on an inner wall of the cavity.

14. A light emitting module comprising:
a light emitting device; and
a reflective member disposed on the light emitting device and including a hole with an inner wall thereof provided as a reflective surface,
wherein the hole has a lower aperture having a quadrangular shape and an upper aperture having a shape geometrically different from that of the lower aperture,
wherein the inner wall includes an inclined surface extending from a respective side of the lower aperture to the upper aperture, the inclined surface having a curvature gradually increasing from the lower aperture toward the upper aperture, and
wherein illuminance distribution of light emitted through the upper aperture on a light emission surface has a substantially quadrangular shape.

15. The light emitting module of claim 14, wherein the inclined surface has the curvature gradually increasing from 0 in a region adjacent the upper aperture.

16. A light emitting module comprising:
a package body having a pair of lead frames;
a light emitting device disposed on of the pair of lead frames; and
a reflective member including a hole and a reflective inner wall surface disposed on the package body, so that the light emitting device is located inside the hole and the light emitting device is surrounded by the reflective inner wall surface,
wherein the hole has a lower aperture adjacent the package body having a quadrangular shape and an upper aperture having a rounded shape, and
wherein an area of the upper aperture is greater than an area of the lower aperture.

17. The light emitting module of claim 16, wherein the inner wall surface includes a first pair of inclined opposing sides extending from the lower aperture to the upper aperture and first widths of the first pair of inclined sides extending along the lower aperture are greater than corresponding second widths of the first pair of inclined sides extending along the upper aperture, and
wherein the inner wall surface includes a second pair of inclined surfaces extending from the lower aperture to the upper aperture and first widths of the second pair of inclined sides extending along the lower aperture are less than corresponding second widths of the second pair of inclined sides extending along the upper aperture.

18. The light emitting module of claim 16, wherein the upper aperture is substantially circular-shaped.

19. The light emitting module of claim 16, wherein the upper aperture is n-sided polygon shaped, wherein n is 5 or more.

20. The light emitting module of claim 19, wherein the upper aperture is substantially octagonal-shaped.
